(19) United States
(12) Patent Application Publication
(10) Pub. No.: US 2007/0179997 A1
(43) Pub. Date: Aug. 2, 2007

(54) COMPUTER BACKUP USING NATIVE OPERATING SYSTEM FORMATTED FILE VERSIONS

(76) Inventor: Malcolm H Nooning III, Pittsburgh, PA (US)

Correspondence Address: MALCOLM H. NOONING III, 112 BOOKBINDER CIRCLE, PITTSBURGH, PA, 15212, US

(21) Appl. No.: 11/307,259

(22) Filed: Jan. 30, 2006

(51) Int. Cl. G06F 17/30

(52) U.S. Cl. 707/204

(57) ABSTRACT

An improved backup storage system and method for use, yielding the effect of employing baseline or full backups at the speed of incremental backups once an initial full backup has been done, with a filtering system to minimize repetitive and unnecessary backed up data, as well as a menu system that promotes ease of use for backing up, restoring and filtering out data, while not requiring any additional hardware on the part of the computer user.

### COMPUTER PROGRAM LISTING APPENDIX

Supplied are a CDROM and a duplicate CDROM. They contain the software portion of the current preferred embodiment of the invention. The CDROM disc and it's duplicate contain the 11 files of the list below.

ReadMe.txt—This file contains instructions for the user, if needed.

install_CHRISM_backup.bat Used to install the software portion of the current embodiment of the invention on computers running Microsoft Windows 2000 and above. If the insertion of the CDROM does not automatically start the installation process, the user is directed in the ReadMe.txt file to run this.

install_CHRISM_backup.sh—Used to install the software portion of the current embodiment of the invention on computers running Linux variants of the Unix operating system such as Slackware Linux 9.0. If the insertion of the CDROM does not automatically start the installation process, the user is directed in the ReadMe.txt file to run this.

autorun—Standard CDROM autorun file for Linux variants of the Unix operating system. If the user computer is set up properly this will cause the installation program to automatically start.

autorun.inf—Standard CDROM autorun file for some Microsoft Windows operating systems. If the user's computer is set up properly this will cause the installation program to automatically start.

autorun.ini—Standard CDROM autorun file for some Microsoft Windows operating systems. If the user's computer is set up properly this will cause the installation program to automatically start.

uninstall_CHRISM_backup.bat—This is a generic uninstall program for emergencies only, for computers running Microsoft Windows 2000 and above. The installation program produces and installs a better uninstall program designed to uninstall the particular installation.

uninstall_CHRISM_backup.sh—This is a generic uninstall program for emergencies only, for computers running Linux variants of Unix such as Slackware Linux 9.0. The installation program produces and installs a better uninstall program designed to uninstall the particular installation.

hi_xxxx.ico—This is an icon for the user to see. The name is temporarily hi_xxxx.ico simply because the current embodiment of the invention does not yet have a more attractive icon with a better name.

CHRISM_backup.exe—This is the executable that gets installed on computers running Microsoft Windows 2000 and above.

CHRISM_backup—This is the executable that gets installed on computers running some Linux variants of Unix such as Slackware Linux 9.0.

### FIELD OF THE INVENTION

The present invention relates to computer data storage, and, more particularly, to backup systems for individual use as well as for system administrators. More particularly, the present invention relates to methods and systems for maintaining continued availability of backed up file versions in local and/or external storage associated with computers, and, in particular, to backup copying of complete file versions, retaining the native operating system file format, which keeps the available file versions readily searchable for file name or for file content with standard search methods.

### BACKGROUND OF THE INVENTION

If the reader is unfamiliar with backing up data, the methods and approaches for doing so, or the terms used such as full or partial backup, or the phrase data sets, he or she is encouraged to browse the USPTO issued U.S. Pat. No. 5,276,860. The USPTO U.S. Pat. No. 5,276,860 details terminology such as baseline, full and incremental backup and backup procedures utilizing separate storage areas, and is a good read for learning the terminology used in this patent application. Concepts such as bit, block, mapping, data sets and the methods for gathering them, to effect full backup, partial backup and so on are therein discussed. For a description of methods employed for gathering data sets, one form of file differencing is described in USPTO U.S. Pat. No. 6,615,225. One form of working at the block level is described in USPTO U.S. Pat. No. 6,871,271. A form of working at the byte level is described in USPTO U.S. Pat. No. 6,526,418. A form of working with noting the differences between bit patterns between a file and a saved copy is described in USPTO U.S. Pat. No. 6,233,589. These patents are mentioned as representative samples of what current technology is doing in the data backup field. They are also specific examples in themselves of the types of methods of gathering data currently employed and may perhaps clarify further the concept of data sets for readers unfamiliar with the concept. The recently issued USPTO U.S. Pat. No. 6,934,822 describes another method, but is really referenced here because its BACKGROUND OF THE INVENTION section applies very well to this invention. Both USPTO U.S. Pat. Nos. 5,276,860 and 6,934,822 are herein incorporated by reference, mainly for their sections on the background of the inventions, and their explanations of terminology, but also as examples in themselves of how backups are currently done.

To reiterate what is stated or implied in the aforementioned patents, a full backup will copy all desired files to a specified backup destination area. A partial backup copies only those files that were newly created or somehow changed since the last backup of such files. In literature such as trade journals, a partial backup is also termed delta, and also termed a difference backup. The full and partial backups are the most likely to be done by a casual user because they are the simplest. A baseline backup is an initial full backup that has been saved for comparison purposes. If you already understand these things, you probably do not need to read the aforementioned patents.

The number of casual computer users has now grown into the many millions. Most of them never desire to become computer savvy to the point where they know how to back up data or to maintain reliable backups of their data. Moreover, most of those that learned a backup method at least once either failed to follow any systematic regimen, or started to, and later discontinued doing so. The primary reasons for not backing up are:

The easiest type, the full backup, duplicates every file every time such a backup is done, and therefore has a tendency to fill up the user's disk space.

Even partial backups tend to fill up disks as they never go away unless the user manually deletes them.

Time must be taken to learn the terminology of the various types of backups.

Time must be taken to actually learn the mechanics of doing the different types of backup.

A backup session takes too long to set up.

A backup session takes too long to run. Especially full backups.

The user must keep records for each backup so as to know the type of backup, and also the content of each backup.

There is not enough positive reinforcement with current methods that would motivate backing up.

Retrieving a backed up file or files is relatively difficult for the casual user.

Instead of positive reinforcement, the current technology gives mainly negative reinforcement. Normally a user does not think about backing up until it is discovered that a file has accidentally been deleted, or when there has been a disk crash. There are much more common negative experiences, too, as for example, when a document is being edited or rewritten and the author wishes that one or more prior versions was readily available for comparison.

Even with such common problems arising from time to time, people still do not back up. The time and complication of finding a backed up file or files within a storage area is a contributing factor. The negative experience of retrieving a file or file leans even knowledgeable computer users towards not backing up. More positive rewards for backing up is what is needed, and needed much more often. Without such positive rewards the casual computer user simply does not maintain a backup system of their computer data.

There are of course solutions to backing up that result in a single copy of each file. Examples are RAID, Redundant Array of Independent Disks, and SCSI, Small Computer System Interface, disk mirroring, and so on. They automatically keep a single backup copy but they are well beyond what the casual user would attempt to employ. Also, the casual user cannot be expected to physically open up a personal computer—PC—to add a card or other piece of hardware. Furthermore, a single backup copy is usually just that. A copy and not a prior version. If an author makes a mistake with an original file, a mirroring system will faithfully mirror the mistake in the copy.

A number of methods currently exist that back up and restore data. Each has a strategy that involves copying all of the desired data into a single, encompassing file, most often called a data set in the literature. The information in a given data set can be in one of many forms: computer bit level, or block level, or just having difference bits or difference blocks from a formerly taken original snapshot, and/or difference bits/blocks from a prior data set of difference bits/blocks, etc. These patented methods are described in the USPTO patents already mentioned.

A data set is, in effect, a single file that contains other data. The data set can be as simple as a file containing all files, either in compressed or in uncompressed form. The data set can also be quite complicated, as with sets of bits, each set of which represents the bits that have changed for given files, along with mapping bits and mapping mechanisms. A central idea of the data set is that whatever the data gathering scheme employed, data, that is, ultimately, files, can be retrieved as it existed at a particular point in time from one or more data sets. The patents mentioned explain a number of methods employed to determine what went where, and when, so that the correct pieces of a file can be put together from the different data sets. As used in the said patents, the methods are sometimes termed data base lookups, with or without storage object routing tables, mapping tables, and so on, in conjunction with the algorithms that employ them.

For example, consider a scheme that takes an original snapshot of the data, and thereafter each backup records just the bits of files that have changed. A request for a file version extraction would entail starting with the file name, using the file name in algorithms that work with that method's data bases and mappings that show which data sets list bit changes for the file in question, to extract the said bit changes, etcetera, to eventually piece together a requested file version for that file name.

Another type of backup would be to have the user copy the root of the directory tree, and everything under it, and copy it to somewhere else. The user could employ the well known drag and drop method here. The operating system would automatically copy the entire directory tree to the new location. Each such copy would be a snapshot of the tree at that point in time. There is no limit to the number of such snapshots that could be made, except of course, that the data backed up cannot exceed the size of the storage media itself.

There are a number of problems with the existing backup methods. All problems are not present in all programs, but most backup programs are afflicted with most. All of these problems are solved with this invention, and they were discussed previously, or will be discussed here and after.

Backed up files in data sets cannot be directly accessed. The files must be extracted from the data set or sets first.

The location of a missing file within an incremental backup is difficult to find. The user must guess as to whether or not the file is within the data set, or else refer to hand kept records. The original backup software, or compatible software, must be used to open up the data set and extract the file. Only then can it be searched by the user's favored word processing software, or by operating system provided search methods.

File content from prior editing sessions is extremely difficult to find if there is more than one backup. For example if the user desires to review how a certain paragraph was worded in one or more previous versions of a document, he must first find and extract the different versions. Since an operating system will allow only one file of the same name in any one directory, the user would have to extract the file versions into different directories, or else rename each one as it is extracted. Only then can favored search methods be used to find the desired content.

Doing a full back up takes a long time. Although full backups simplify the backup process and eliminate the problems inherent with incremental backups, it takes a long time to complete. Yet it is the back up of choice because the user will not have to remember what files were backed up because he knows that they all were. The user typically does not want to have to remember what files were modified, in what directory, etcetera, since the last backup. It takes so long to do, however, that users quickly tire of doing it. Eventually they simply do not do it even though they know they should. Even a user that is used to backing up would balk at the idea of backing up a large hard disk just to back up a small amount of new work that had just been done. This would be especially true if the user suspects he will be doing additional work within a short time period.

A small physical glitch can wipe out all the backed up data. If there is a glitch in the bit/block map of a disk data set, the data set cannot be recovered. The glitch problem with tape backup software and the tape drives is worse. If there are a number of backups on a tape drive and there is a glitch in the tape, the tape becomes unreadable beyond the glitch point. All data sets after that are lost.

A user may want more than one immediately available backup scenario. A user may typically work on documents stored in one disk directory area, and want just that area backed up. At other times the user may want to back up a different disk area, and at other times everything. The user would want to easily switch from one scenario to the other. For example, a researcher or student with multiple tasks may have the work of the tasks sectioned off into entirely different directory areas, wanting only the area being worked in to be backed up at a given time. With current backup software, there are too many steps involved with changing from one area to another. The current technology is not adaptable to quick changes.

The most common backup, full backup, quickly fills up even large hard disks. Each data set contains all of the targeted files. Therefore the data on the storage media grows by the size of each and every file that is backed up with every full backup.

The next most common backup, partial backups, also fill up disks too readily if the user does it on a regular basis. Just like full backups, partial backups remain in the backup area unless the user manually removes them.

Getting rid of excess backups is very dangerous. If a user does have the discipline to back up, the backups will occur frequently. To prevent the storage media from overfilling, there must be a purgation, or filtering, of unneeded data sets. Unfortunately there is no way to know or decide what data set can or cannot be removed. For example, suppose there were twenty full backup data sets. Some earlier data sets may have files or content that later ones do not. If there were thousands of files in each, which is quite normal, it would be impractical to go through each data set one by one, and determine if there were any files missing before removing any of them. This is also true if different file versions may later be needed due to file content changes, which is again quite normal. With current technology, as the disk becomes full the user must either delete the oldest data sets and hope for the best, or must purchase new media to transfer the older data to, with the concomitant record keeping.

Before stating the objects of this invention, let me state that if the Examiner believes that there is patentable subject matter disclosed in the present application, but he does not feel that the present claims are technically adequate, he is respectfully requested to write acceptable claims pursuant to MPEP 707.07(j), a copy of which is shown as the paragraph immediately below.

707.07(j) State When Claims Are Allowable Inventor Filed Applications. When, during the examination of a pro se case, it becomes apparent to the examiner that there is patentable subject matter disclosed in the application, the examiner shall draft one or more claims for the applicant and indicate in his or her action that such claims would be allowed if incorporated in the application by amendment. This practice will expedite prosecution and offer a service to individual inventors not represented by a registered patent attorney or agent. Although this practice may be desirable and is permissible in any case where deemed appropriate by the examiner, it will be expected to be applied in all cases where it is apparent that the applicant is unfamiliar with the proper preparation and prosecution of patent applications.

### OBJECTS OF THE INVENTION

It is an object of the invention to have a backup solution that is not excessively prone to filling up a user's allotted disk space.

It is also an object of the invention to eliminate the need for the concept of data set completely.

It is an object of the invention to have a backup solution in which a request for a backup results in the equivalent of a full backup even though only newly created or modified files have actually been copied to the backup area. The other, older files are already there which, in effect, gives the user the equivalent of a fast speed full backup every time.

It is also an object of the invention to eliminate the need to learn backup terminology such as full, differential and partial, and with it the need for a casual user to have to learn about such things in order to use the backup program.

It is another object of the invention to allow the users to use their favored search methods to search for file or directory names. For example, when the user utilizes the Search or Find window selections that most operating systems come with, the user simply directs the operating system search or find program to look in the backup area. Most major word processing software also comes with a search/find mechanism, which it is an object of the invention for the user to also be able to directly use on the backed up files.

It is another object of the invention to allow the users to use their favored search methods to search for file content. For example using the Search or Find window selections that most operating systems come with will also allow for searching the content of the files for keywords. Most major word processing software does, too, which it is an object of the invention for the user to also be able to use on the backed up files.

It is another object of the invention to provide the user with a system wherein the steps for backing up or recovering do not have to be remembered. That is, each window has sufficient verbiage and/or context sensitive help buttons to guide the user at each step in either the back up process, or the recover process.

It is another object of the invention to allow the backed up data to be easily retrievable. A file's versions exist in their entirety, with only slightly modified file name extensions. Therefore the user can choose between using the software of the invention to retrieve a file version, or utilize his or her favorite program to do so. For example if the file in question is a letter, the user can simply read in the backed up file or otherwise copy it as desired.

It is another object of the invention to provide an easy method of use. The current embodiment sleeps in the background until awakened by the user mouse clicking—also termed pressing—a button.

It is another object of the invention to allow for specifying what to back up in an impromptu or ad hoc manner. Clicking on an Edit button on the Main Menu of the preferred current implementation leads to single window with: a data entry box wherein the user can place, using drag and drop or by typing a file name in directly, or pasting the name, etcetera, specific file names; a data entry box wherein the user can place directory names wherein just the files of those directories will be backed up, and not the files of any of their subdirectories, using the same methods as for the single file entry box; a data entry box wherein the user can place directory names wherein the files of those directories, and all files of all subdirectories of those directories, will be backed up, using the same methods as for the single file entry box.

It is another object of the invention to provide the user with a data entry box for changing the date wherein only those files that were created or modified on or after that date will be backed up, commensurate with the rules of the three aforementioned data entry edit boxes.

It is another object of the invention to provide the user with a data entry box for naming the location of where to back things up to, whether the current storage media or a different storage media.

It is another object of the invention to provide the user with an intelligent means of filtering out unneeded files, thereby making the storage media much less likely to fill up. This is also termed purging unneeded files. The included excess file filtering system limits the amount of additional storage that would otherwise need purchased and installed.

It is another object of the invention to provide the user with a backup system such that the end result will look like a full backup has been taken, but at the speed of a partial backup, once a first full backup has been done.

It is another object of the invention to not need any computer hardware other than what normally comes with so-called personal computers of the day, and also to work with hierarchical or mass storage servers and networks, if available. In other words, to work with any appropriate storage media that the computer operating system makes available to the user.

It is another object of the invention to provide a backup system wherein the user is apt to back up even small amounts of new work due to the ease of use, positive reinforcement, and also the speed at which the backup is done. That is to say, the user can very quickly tell the backup system to focus on a specific area for backup, and then while working, be backing up just the focus area at each touch of a button. The backup will be very quick and yet will be the equivalent of a full backup. The user is apt to do it because there is satisfaction in knowing that what you have just done on a computer has been backed up. This is positive reinforcement that in itself promotes the use of the invention due to the said satisfaction.

### BRIEF SUMMARY OF THE INVENTION

In accordance with the present invention, there is provided a method of backing up data wherein each backup results in the equivalent of a full backup of files into a storage area wherein each file version is always readily available to standard search methods, never duplicated, and which each equivalent full backup is done at the speed of a partial/differential backup, after the initial full backup has been performed. This is accomplished by having a backup area that has special root name, under which is a tree whose directory names are the same as the originating directories. Each file version is copied in it's entirety, with the original name kept, except that a special character, underscore or other character, followed by a special timestamp such as a 14 digit timestamp, is attached to the file names as they are backed up, such as to the last part of a filename as a suffix. The end result is that each file version can exist in full, in the original like named directory under the backup tree. No file ever needs backed up again unless it is a newly created file, or unless the file has changed in some way, in which case it would be backed up. In the current embodiment, the timestamp is in the form YYYYMMDDhhmmss—Year Month Day hour minute second—form. The current embodiment provides a system for restoring data. The current embodiment also provides an overall system that facilitates ease of use, and an intelligent excess backup file versions filtering.

### BRIEF DESCRIPTION OF THE SEVERAL VIEWS OF THE DRAWING

A complete understanding of the present invention may be obtained by reference to the drawings when considered in conjunction with the subsequent detailed description, in which, in the current embodiment of the invention:

FIG. 1 is a depiction of a typical target of the invention;

FIG. 2 is a depiction of the Main Menu;

FIG. 3 is a depiction of the Entering File and/or Directory Names window;

FIG. 4 is a depiction of the window for entering where to back up to;

FIG. 5 is a depiction of the set/change oldest date window for backing up;

FIG. 6 is a depiction of the set/change oldest date window for recovering;

FIG. 7 is a depiction of the Recover Menu window;

FIG. 8 is a depiction of the Advanced Menu window;

FIG. 9 is a depiction of a help window derived from the above mentioned Entering File and/or Directory Names window;

FIG. 10 is a depiction of the window for deciding what should be done with a recovered file;

FIG. 11 is a depiction of the window for deciding what should be done with a recovered directory folder;

FIG. 12 is a depiction of the window for deciding what should be done with a recovered directory tree;

FIG. 13 is a depiction of the window for entering where to put a file if there is a possible need for creating a new directory for it;

FIG. 14 is a depiction of the window for a last check for the recovery of data;

FIG. 15 is a depiction of the window that appears after a recovery process completes;

FIG. 16 is a depiction of an example directory structure comparing the original versus backup directories; in the current embodiment.

While the invention is susceptible to various modifications and alternative forms, a specific embodiment thereof has been shown in the drawings and will be described in detail. It should be understood, however, that it is not intended to limit the invention to the particular forms shown, but on the contrary, the intention is to cover all modifications, equivalents, and alternatives falling within the scope of the invention as defined by the appended claims.

### DETAILED DESCRIPTION OF THE INVENTION

This paragraph is meant as a preface to the detailed description of the invention. I will seek to describe the invention if full. Often the types of things stated in patents can be stated correctly, but still be conceptually unclear. I will here endeavor to prevent that sort of thing by describing the invention by using depictions of the windows that appear for the current embodiment of the invention as visual aids for most explanations. In pursuit of this goal, I created depictions of most of the current embodiment's display windows that are popped up, if I may use that colloquial expression. I included in the depictions the actual verbiage that is on the titles, explanations, labels, buttons, and so on, and I refer to them in the explanations.

Describing things such as windows and numbering each item in each depiction entails quite a bit of repetition due to the necessity of having to describe the same kinds of buttons on many windows. To prevent some of this I would like to first list what I hope are the more self-evident window buttons and describe some common windows and other common items before going on to the better flowing explanations of the invention.

First, there are many buttons that have the same purpose, such as the buttons that have the following verbiage: Main Menu; Exit; Save; Discard; Back; Recover. Each does pretty much what you would expect such named buttons to do.

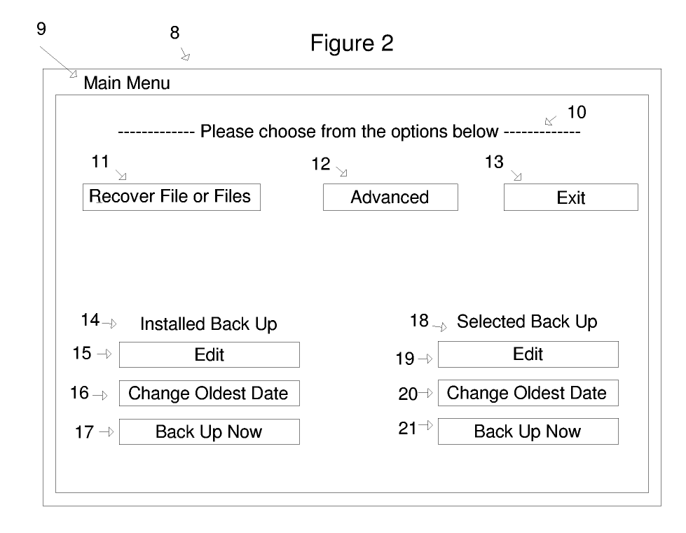

Main Menu buttons 39, 58, 72, 86, 100, 110, 125, 134, 143, 157, 168, and 176, which lead the user back to the Main Menu window of FIG. 2, item 8.

Exit button 13, 40, 59, 73, 87, 101, 111, 127, 136, 145, 159, 170, and 178, all exit the program.

Save buttons 36, 55, 69, and 83 save whatever the user entered in appropriate entry boxes of the currently showing window, and refreshes the currently showing window.

Next buttons 37, 56, 70, and 84 close out whatever current window is showing and the invention goes to whatever is the next invention window to be displayed.

Discard buttons 38, 57, 71, and 85, discard whatever the user entered in the appropriate data entry boxes of the currently showing window, and refreshes the currently showing window using the previous data of the said boxes.

Back buttons 54, 118, 156 and 167 all close out the currently showing window and the invention goes back to whatever prior window was showing.

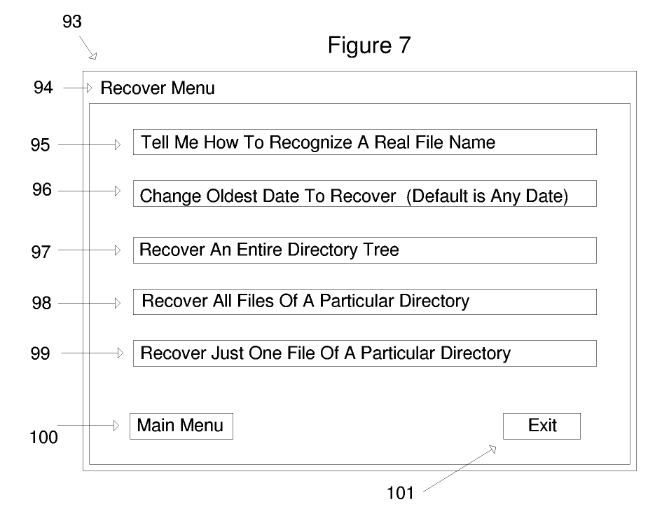

Recover Menu buttons 126, 135, 144, 158, 169 and 177 close out the currently showing window and the invention goes to the Recover Menu 93 of FIG. 7.

Help buttons 41, 42, 43, 60, 74, 88, and 112 pop up a separate help window. They do not close out the currently showing window, whatever it may be.

Second, there is a title at the top of each window that is meant to give the user a clue as to what the currently showing window is all about. Some have the same title since they are about similar things.

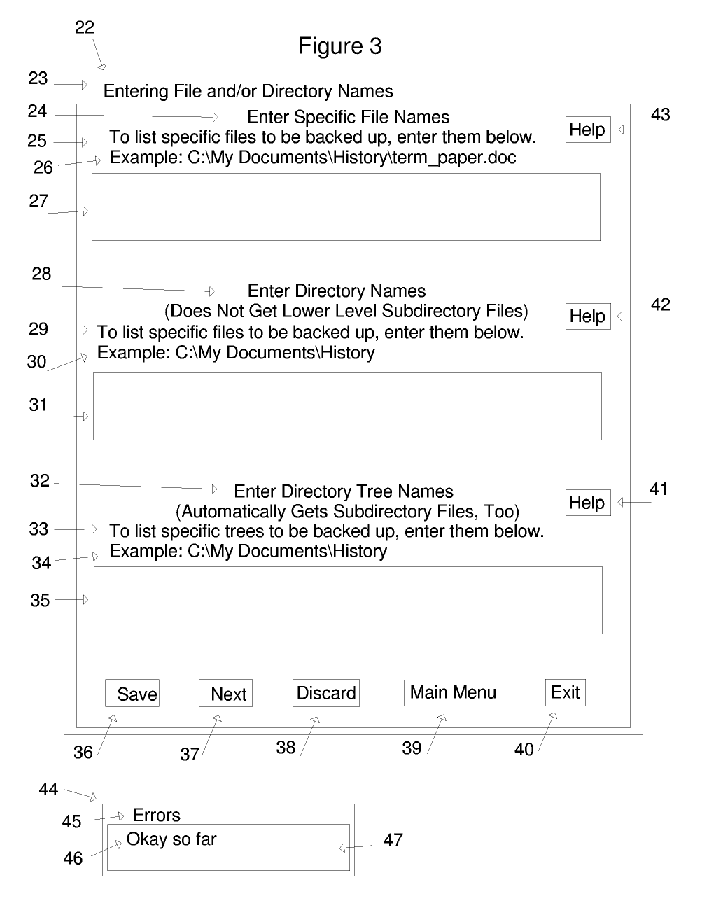

FIGS. 3, 4, 5 and 6 each have similar Error windows 44, 61, 75, 89 respectively. Error titles 45, 62, 76, 90 state what the window is for. Their respective message boxes 47, 64, 78, 92 show either an Okay sort of message 46, 63, 77, 91 respectively or show verbiage describing errors.

FIGS. 10, 11 and 12 all have the title Question 120, 129, and 138, respectively. Their respective windows are 119, 128, and 137. The three each have a question 121, 130 and 139 respectively and show a file, directory or tree name 122, 131, 140, respectively.

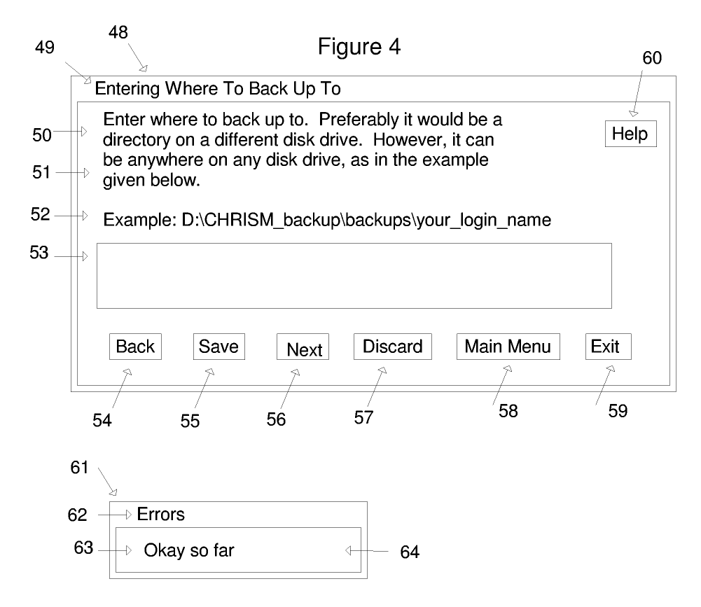

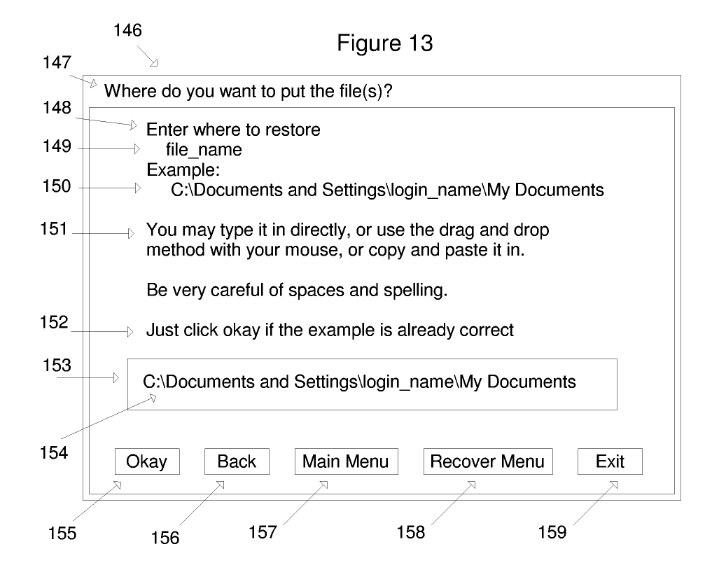

Third, in various windows in this discussion, you may encounter verbiage such as login_name and/or your_login_name. For example FIG. 4 item 52, FIG. 13 items 150 and 154. Such verbiage is translated by the current embodiment into the user's actual login name. All current target operating systems such as Microsoft Windows 2000 and above, Unix, Linux and so on all automatically assign such login names.

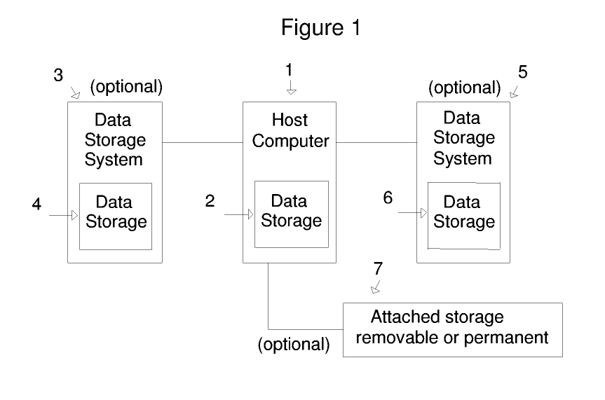

I would here like to state the USPTO required a suggestion for a drawing to be used for the representative shown drawing of the final, issued patent. It is FIG. 1, which shows a typical target of the invention.

Before proceeding I would like to clarify the idea of a file/directory/tree browser, known from here on simply as a browser, and also how it is used. The current embodiment utilizes a third party browser. It is one of the so called open source browsers. Examples of browsers are Konqueror for the Linux operating system and Windows Explorer for the Microsoft Windows 2000 and above operating systems. As an example of browser use, clicking on a Documents directory icon in the Microsoft Windows operating system, or in a number of Linux operating system variants, will result in a window popping up that shows the files and directories of the Documents directory. The software that pops up the window, and the window that pops up, is known colloquially as a browser. Since the said browser is third party, details of it will not be discussed except to say that the current embodiment invokes it when any of the three FIG. 7 Recover Menu buttons 97, 98, 99 are pressed. The said browser helps the user select the file, directory or tree desired for recovery. From this point on, the word browser will be used to mean either the included said third party browser, or one of the many that can come with the user's operating system, or downloaded and installed from any source allowed by the operating system. For the purposes of this invention, they are all used in the same manner.

I will now proceed with a description that the reader hopefully can readily follow.

Again, FIG. 1 shows a typical target of the invention. The software part of the embodiment would run on the host computer 1 with the backups being stored in the local Data Storage 2 area of that host computer. Optionally, the storage area could be the Data Storage System of 3 and/or 5, or even additional data storage systems, each of which could be data storage systems per se, or other computers with their own local and/or remote data storage options. The current embodiment of the invention will use any storage media that the Host Computer's operating system properly makes available to it, whether local or remote to the host computer. For example, an optional local attached storage unit is depicted as 7 in FIG. 1.

For ease of description, many explanations will be from the starting point of the Main Menu FIG. 2, item 8, as implemented in the current preferred embodiment of the invention. Ordinarily the user would simply click FIG. 2 Back Up Now 17 or 21, but for purposes of explanation we will go through each of the windows of the current embodiment's Main Menu.

FIG. 2 shows the Main Menu of the current embodiment. Item 8 is the window that pops up upon the current embodiment's invocation. Item 10 is a suggestion for the user as to what to do next. Items 14 and 18 are titles for the two button groups 15, 16, 17 and 19, 20, 21 under the two said titles, respectively.

Main Menu area titles 14 and 18 are also meant to imply that the three buttons underneath each are for different backup scenarios, although they both could be the same if the user wanted them that way, to be explained.

The title Installed Back Up 14 is so named because it starts off containing the settings entered by the user when the user was first prompted for them during program installation. The user is free to change the said settings at any time.

The Selected Back Up title 18 contains the same sort of settings like the Installed Back Up 14 settings. The invention does not limit the number of back up areas to the two shown. There can be as many Selected Back Up areas such as 18, with the accompanying associated buttons like 19, 20 and 21 as could be shown on a user's screen. Larger computer monitors with finer pixel resolution could show more than smaller monitors would. A prior embodiment had several such Selected Back Up 18 areas and associated buttons but the current embodiment has been limited to just two total areas 14 and 18 so that the Main Menu will fit well on the smaller computer monitors and ones that have lower pixel resolutions.

Here is an explanation as to the intended usage of the different back up areas. Let us suppose that the computer user was a student with a root directory tree called, simply, Documents. Suppose further that the user had directory subtrees History, Science and Mathematics, all under the directory Documents. Here this is denoted as subtrees Documents\History, Documents\Science and Documents\Mathematics.

Using the buttons of Installed Back Up 14 one would typically find the settings such that the entire directory tree Documents would get backed up if the Back Up Now 17 button under Installed Back Up 14 was pressed. On the other hand, if the settings under Selected Back Up 18 was just for the History area, then only the Documents\History area would get backed up when the Back Up Now 21 button for that area 18 was pressed.

The Edit buttons 15 and 19 of the Main Menu both lead to the same type of window as shown in FIG. 3, window 22, with title 23 Entering File and/or Directory Names. This window is one of the ways the invention makes it easy for the user to change settings. The content of the three data entry boxes 27, 31 and 35 is what the user changes. The three verbiage groups 24, 25, 26, and 28, 29, 30, and 32, 33, 34, respectively above each of the said boxes, are meant to make the purpose of the boxes self explanatory. The examples of file or directory names above each box 26, 30 and 34 would really be actual directories discerned by the software of the current embodiment from the user's real directory structure. The current embodiment has sufficient artificial intelligence to determine the user's actual directory structure and make directory example recommendations accordingly, for a number of currently targeted operating systems such as Microsoft Windows 2000, Microsoft Windows XP, and Linux. These examples, along with the said verbiage above each box, greatly aid the understanding of the use of each box.

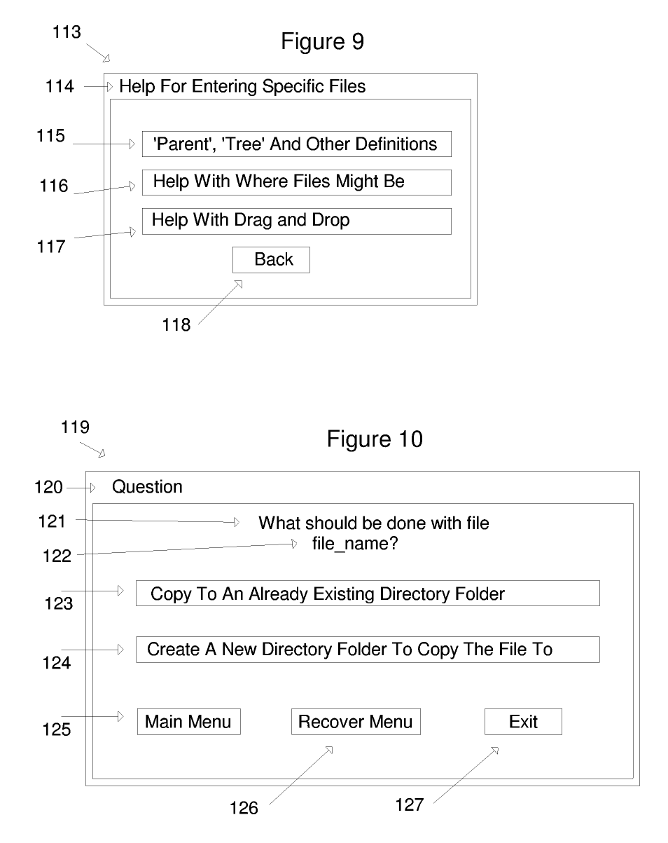

For all three boxes 27, 31 and 35 there are context sensitive help buttons 43, 42 and 41, respectively. The help window that pops up in the current embodiment after pressing Help button 43, for example, is shown as 113 in FIG. 9. FIG. 3 window 22 stays up with the help window such as that of FIG. 9. As the FIG. 9 title 114 suggests this is a Help For Entering Specific Files. As FIG. 9 shows, there are three more buttons 115, 116 and 117 that refine the help messages further, as desired. There are three Help buttons 43, 42 and 41 to the Entering File and/or Directory Names window because each is tailored for help for the boxes 27, 31, or 35, respectively, associated with it. Put another way, there are three different helps: help button 43 for entering specific files; help button 42 for entering directory names all of whose files will be backed up, but not files of subdirectories; help button 41 for entering directory tree names all of whose files and subdirectories will be backed up. The back button of a help menu such as the FIG. 9 Back button 118 would close out only that particular help window.

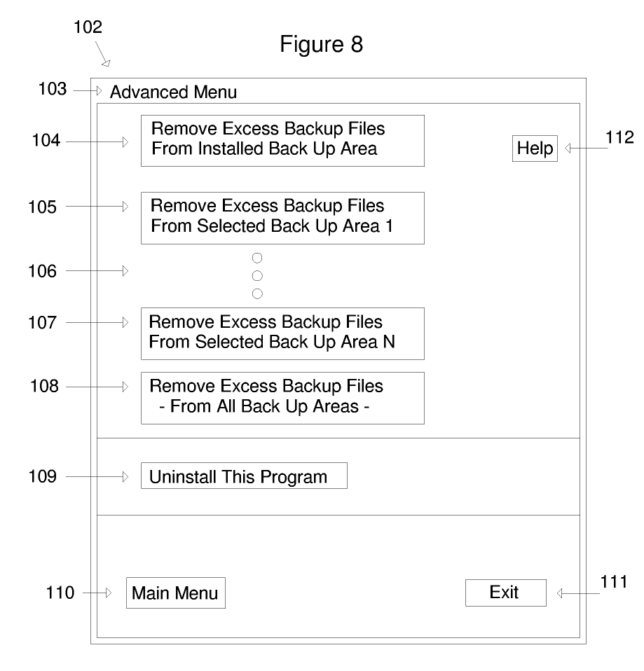

On the said FIG. 2 Main Menu 8, the user would press the Recover File or Files button 11 to enter a FIG. 7 Recover Menu 93 window, which title Recover Menu 94 states. Similarly, the FIG. 2 Advanced button 12 leads to the FIG. 8 Advanced Menu window 102, which bears the title Advanced Menu 103.

The data of the FIG. 3 data entry boxes 27, 31 and 35 can be modified as desired using any method normally allowed by the operating system. For example the user can type things in directly. The user can copy the names from anything the operating system allows the user to copy from, and paste them into a data entry box. The user can use a browser to get to where a desired file or directory shows on the screen somewhere, and then use the mouse cursor to drag and drop the file or directory name or icon into the invention window data entry box of choice. This is true for all of the data entry boxes throughout the current embodiment of the invention, if allowed by the operating system.

The separation of the said data entry boxes, along with the box appropriate directions and said help buttons immediately near the said boxes, refine the explanations, as well as the tasks, into small enough steps to be comprehendible to the more casual computer user. Thus the user is self guided at each step to complete tasks such as setup or edit without the need for a manual or other separate guide, and without having to remember anything about the backup process before hand.

The current embodiment of the invention also makes it easy to specify what does and does not get backed up with the use of the pound sign # as the first character on a line in the FIG. 3 data entry boxes. If a line in one of the three said boxes begins with a pound sign, it is ignored. Conversely, if the pound sign is removed the invention will once again acknowledge the line. This greatly reduces the tedium of removing undesired items and having to add them again at a later time, and vice versa, which can happen often as a user switches from working in one area of his computer to another. Like other ease-of-use aspects of this invention, this feature encourages the computer user to make use of the invention.

Each of the previously stated Save and Next buttons do error checking, unbeknownst to the user, on the entries of their associated boxes. For file and directory entries, it checks for illegal characters, those not allowed by the operating system in question, for the actual existence of each item entered, and clean up such as removal of blank lines, of beginning and ending spaces, and so on. If there are any errors, they are reported in FIG. 3 window 44 box 47. The depiction of FIG. 3 item 46 shows an Okay so far type of message, which is what is normally shown. When an error occurs, the invention identifies and displays the problem, and prompts the user to correct the error. In like manner, if the entry is supposed to be a date, the invention checks the date entered for validity. The invention always displays error messages in separate windows from the data entry windows. Thus the invention allows the user to easily view the errors in one window while making corrections in the associated data entry window.

While in the FIG. 3, clicking on Next 37 in the current embodiment will close out the window and bring about the FIG. 4 Entering Where To Back Up To window 48, which is naturally for entering where to back up to, as suggested by the title 49.

The FIG. 4 Back button 54 will return the user to the FIG. 3 window 22. Again, and importantly, a main goal of the invention is for the invention to be self explanatory, and thereby easy to use. Like in other windows, the FIG. 4 data entry box 53 associated explanations 50, 51 and 52 and the associated Help button 60 further that goal. Note that the place the user specifies to back up the data to in data entry box 53 can be any location that the user's operating system will permit, be it local or remote. It can be a storage device on the host computer like FIG. 1 item 2, on a remote system such as depicted as FIG. 1 Data Storage System 3 storage device 4, or FIG. 1 Data Storage System 5 storage device 6, or a local attached storage device 7.

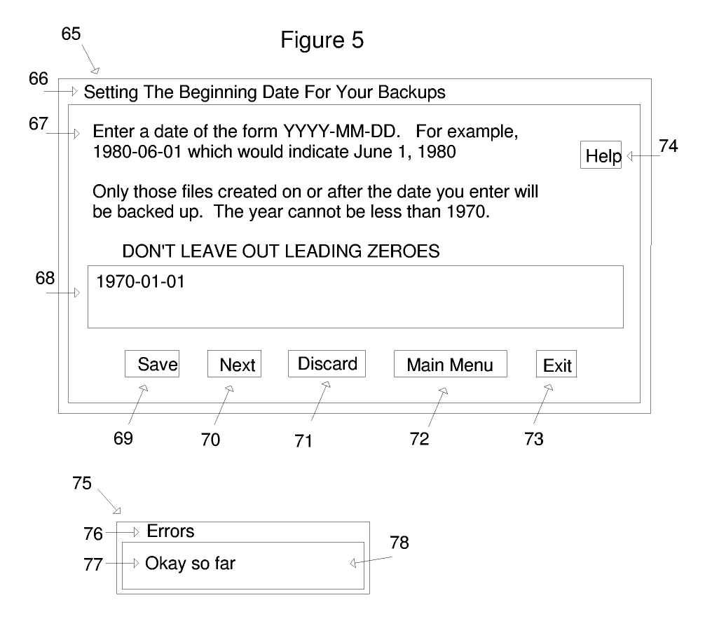

When the FIG. 4 Entering Where To Back Up To window 48 is displayed, pressing Next 56 will close the windows 48 and 61 and then display the FIG. 5 windows 65 and 75, which are for changing the date for backing up, as suggested by the title 66 Setting The Beginning Date For Your Backups.

The FIG. 5 verbiage 67 exists because the concept of changing a date for backing up is generally unclear to a casual user. As previously stated, a goal of this invention is to make the backup and recovery process easy for users, and also one that does not have to be remembered, hence the Help button 74. In any case, as the said verbiage indicates, only those files created on or after the date entered in FIG. 5 data entry box 68 will be backed up.

The first time through the user of course will have to actually read the text in the different windows, including perhaps the help windows. After that, the user of the invention will simply ignore the context sensitive text and help aspects, and just click the desired buttons. If the user forgets, the text surrounding the windows and buttons, and also of the help button displays, is there to remind him each step of the way.

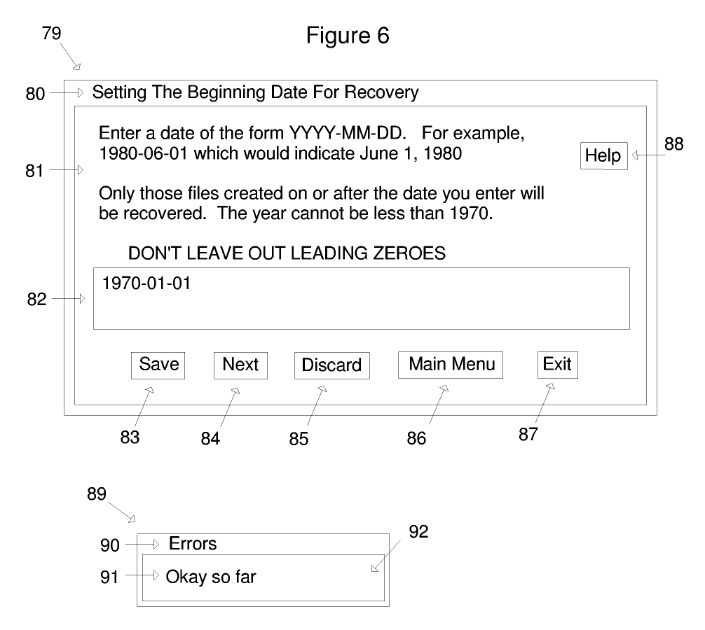

The actions of the FIG. 5 Next button 70 during the setup procedure leads to FIG. 6 window 79, which is explained further down. Thereafter it leads to the Main Menu of window 8.

While in the Main Menu 8, the user can change the oldest date for backing up for any given area by pressing the Change Oldest Date button for that area 16, 20. Or the user can press the Back Up Now button for the desired area 17, 21.

While in the Main Menu 8, the user can press the Recover File or Files button 11 which would close out the Main Menu and open the Recover Menu 93 shown in FIG. 7. In essence, the invention looks at the timestamps in the backed up file names to determine their dates when restoring.

The concept of a single file name with multiple appended timestamps is heretofore unheard of by the casual user, so a special button was created with a reminder of how to recognize file names. In FIG. 7, there is a button 95 that has the text Tell Me How To Recognize A Real File Name. Pressing the button will lead to a window with descriptions and examples of how the timestamp is appended onto the real file name. The window is not shown in this patent application. The descriptions illustrate how a file name can exist with several timestamp extensions appended on the name. The descriptions assume that the user has never seen such a thing before and are very explicit. There is an Okay button, not shown, in the said explanation window that simply leads back to the said Recover Menu 93 of FIG. 7.

In FIG. 7, the button 96 labeled Change Oldest Date To Recover (Default is Any Date) leads to FIG. 6 windows 79 and 89, which are used for changing the oldest date of files to recover, as evidenced by the title 80 Setting The Beginning Date For Recovery. The FIG. 6 verbiage 81 and Help button 88 serve the same purpose as the FIG. 5 verbiage 67 and Help button 74, with the former for recovering files and the latter for backing up files. With recovery, only the files created on or after the date entered in FIG. 6 box 82 will be recovered. FIGS. 5 and 6 both start with the well known birth of Unix date, Oct. 1, 1970, in their respective data entry boxes upon installation. The easy variability makes it possible to quickly recover all files created or modified during the current day, or since yesterday, or since use of the computer began. The FIG. 6 Next button 84 will lead to the Recover window 93 if it came from there. Otherwise it leads to the Main Menu window 8.

The three FIG. 7 Recover Menu 93 buttons 97, 98 and 99 works with a third party browser that the current embodiment invokes when any of the said three FIG. 7 buttons 97, 98 or 99 are pressed in order to help the user select a file, directory or tree desired for recovery.

The current embodiment of the invention uses the aforementioned browser to locate and show the correct backup area to the user. It will show the same backup directory entered by the user in FIG. 2 under area Installed Back Up 14 the last time FIG. 4, entry box 53 was edited. The user therefore does not have to remember, or hunt around, for this backup directory area. As with most browsers, the user may browse up or down directory trees as desired. The user will easily recognize the directory and file names because except for the special root name of the backup tree, the names are the same as the original directories and files with one exception. Namely, in the current embodiment, the backed up files have an underscore and a 14 digit timestamp appended at the end of each file name. For example the file my_file.doc could be named my_file.doc_{—}20030225150506 in the backup directory. Other embodiments could have the timestamp embedded elsewhere such as my_file_{—}20030225150506.doc. Just so it is embedded somewhere in the name, and is always consistently placed. Again, the current embodiment has it at the end as in my_file.doc_{—}20030225150506.

In the current embodiment the third party browser does an error check. In particular, for FIG. 7 button 99, Recover Just One File Of A Particular Directory, it will check to ensure that what is selected is indeed a file name, and not a directory name. Likewise, the said browser will check that what is selected is indeed a directory name and not a file name, if it was invoked via FIG. 7 buttons 97 or 98. The current embodiment of the invention is always cognizant of whether it is working with a file or a directory.

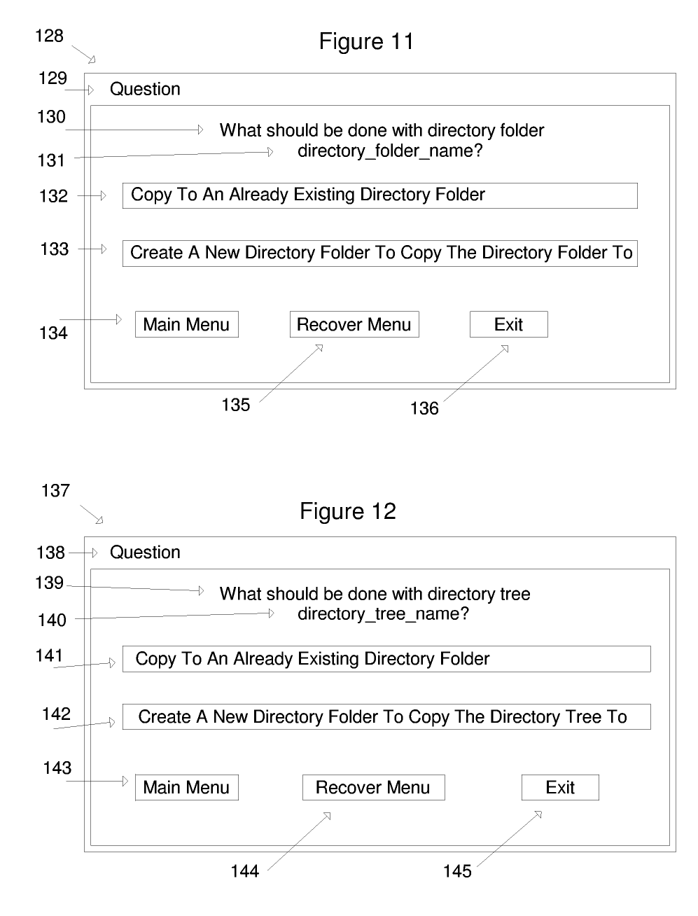

Once the user selects the file, directory folder or directory tree to be restored, the said third party browser releases the user selection to the invoking software of the current embodiment of the invention. The invention will then display one of the three FIGS. 10, 11, or 12 as appropriate for restoring a file, a directory full of files, or a directory tree, respectively. The three FIGS. 10, 11 and 12 are identical except for the file/directory/tree appropriate verbiage in their respective windows 119, 128 and 137. Having the restoration process broken up into small steps like this furthers the goal of guiding a casual user without needing a manual.

The FIG. 10 buttons 123 and 124 are identical to those like named FIG. 11 buttons 132, 133 and FIG. 12 buttons 141, 142. The verbiage on each button makes their purpose self evident. The button verbiage shown is the actual verbiage in the current embodiment of the invention. The ones labeled Copy To An Already Existing Directory Folder 123, 132, 141 will close the currently showing window and pop up the third party browser. The current embodiment of the invention uses artificial intelligence to cause the browser to automatically show the original directory from where the backed up file came. As before, the user can browse up or down directory trees as desired to select where to put the file, directory or tree.

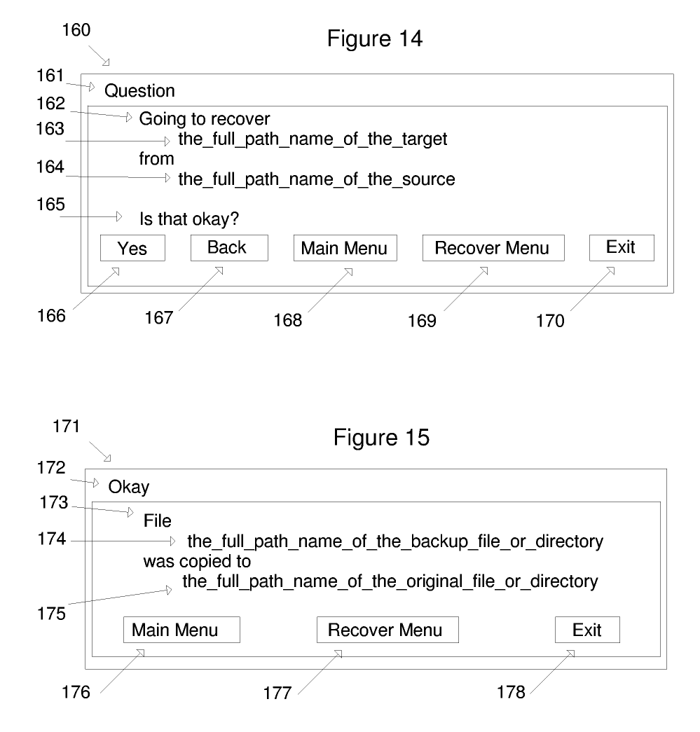

While in FIG. 10 window 119, if the user selects a button to Create A New Directory Folder To Copy The File To 124, or the similar buttons 133 or 142, the invention will close out the current window and show the FIG. 13 window 146 with the data entry box 153 where he can enter the location where the recovered file, directory or tree, as appropriate, should be placed, as evidenced by the title 147. The FIG. 13 examples 150 and 154 will initially be the directory from which the backed up file, directory or tree, as appropriate, originally came from. The texts of 148, 149, 151 and 152 also aid the casual computer user in figuring out exactly what to do. The invention, via Okay button 155, accepts whatever was entered, does the appropriate error checking and then shows the FIG. 14 window 160, which is titled Question 161.

Let us now follow the recovery of a single file as a representative recovery example. Starting from the FIG. 2 Main Menu, the user would press button 11 Recover File or Files, which would show the FIG. 7 Recover Menu. The user would then press button 99 Recover Just One File Of A Particular Directory, which would then close out FIG. 7 and show the said third party file browser, not shown. The user would use the said browser to make a selection. The browser has an Accept button that would then close out the browser window. FIG. 10 would then be shown, which asks What should be done with file file_name. Let us suppose that the user then pressed button 123 Copy To An Already Existing Directory Folder. The said browser would then reappear showing the original directory where the backed up file came from. The user would then normally press the Accept button on the browser, which would then close out the browser. FIG. 14 window 160 would then show. The user of course could also have browsed the directory trees in order to navigate to some other directory to place the file there. The FIG. 14 window 160 and its verbiage 162, 163, 164, 165 gives the user one last chance to change his mind. Pressing the Yes button 166 will result in the recovery actually taking place. Once the recovery is done, the FIG. 7 Recover Menu window 93 will reappear. Throughout this process, only one window is showing at a time. The procedure for recovering a directory, or for a directory tree, would be the same except that FIG. 11 or 12, as appropriate, would show instead of FIG. 10. Also, the verbiage along the way would reflect directory or tree, as appropriate. Again, these small steps are aimed at guiding a casual user.

For FIGS. 10, 11, 12, the buttons 124, 133, 142, which are for creating a new directory to receive the recovered data, will lead to FIG. 13 window 146. Again, the three FIGS. 10, 11 and 12 are identical except for the file/directory/tree appropriate verbiage such as file_name 149, directory_folder_name 131 and directory_tree_name 140. As with other such symbolic pictorial names, the verbiage will be the actual file, directory or directory tree name, respectively. Also the FIG. 13 example 150 and initial data entry box 153, entry 154, will both be the artificial intelligence derived original directory from which the file/directory originally came. This frees the user from having to comprehend the details of this aspect of the backup process. Typically only a more knowledgeable user would want to restore to a different place. If the user does want to restore to a different place, he can enter it in the data entry box 153 provided.

Pressing FIG. 13 Okay button 155 will close out the window 146 and show FIG. 14 window 160. This is a last double check for the user. As usual, the symbolic names the_full_path_name_of_the_target 163 and the_full_path_name_of_the_source 164 will be the real ones that the user selected. If the user selects Yes 166 the recovery will take place. All successful recoveries whether file, directory or tree, will result in the FIG. 15 Okay 172, window 171, being displayed. In FIG. 15, the verbiage 173, 174, 175 reassure the user as to what had just occurred.

As previously stated, the FIG. 2, Advanced button 12, leads to the FIG. 8 Advanced Menu window 102 in the current embodiment. Buttons 104 and 105 are the two buttons that are in the current embodiment for removing excess backup files. However, the dots of 106, which imply more than one button, and buttons 107 and 108 are examples of what could be added. There can be any number of such buttons. The current embodiment, however, has only two, namely 104 and 105. One button is for the aforementioned Installed Back Up area 14, and one is for the aforementioned Selected Back Up 18 area. In the current embodiment the text of the shown button 105 excludes the numeral 1. The Help button 112 leads to a window, not shown, with a very detailed explanation of the terms Installed versus Selected, for intelligently removing excess backup files. Again, one of the purposes of this invention is to have a system wherein the user does not have to comprehend the backup process, or remember the steps involved. Instead, the invention guides the user with in-window verbiage and with context sensitive help buttons such as 112.

When the user presses a FIG. 8 removal button the current embodiment executes the request and returns automatically to the already discussed FIG. 2 Main Menu.

Also shown on FIG. 8 is the Uninstall This Program button 109, which will do just that. Not shown are the pop up windows that make sure that the user really wants to uninstall the program.

Now begins the explanation of the process the invention uses for excess backup file version removal. This is sometimes called filtering and sometimes called purging. In any case the excess backed up file versions are removed.

Assume for the purpose of explanation that there is a particular file with backup file versions from different days in a given back up area. Consider further that for at least three of those days, each could have a number of backup versions, of the said particular file. In other words, there could exist a number of file versions in the backup area from each day just for the one particular original file. Now consider that a filtering of that backup area was requested.

If the original file has not been modified in a maximum number of months, currently six months in the current embodiment, then only one file version will be kept in the backup area. Namely, the newest file version of the newest day.

If the file has been modified during the last six months, then only but a set maximum number of days worth of file versions for that file will be kept. In the current embodiment, up to three different days worth of file versions are kept. Namely, the newest three days of file versions. All file versions from any previous days will be removed.

Now assume for purposes of explanation that the file in question, in the area in question, has indeed been modified within the last six months. Of the days kept, if the newest version is from the current day, all file versions from the current day will be retained in the backup area. The current days backed up file versions are never removed no matter what the scenario. In this case there will be a maximum of three backup files retained from the next newest day, and a maximum of three from the next newest day. Namely, the newest three versions from each of those two older days, if they exist. In other words, all other versions from the kept days are removed, and any fourth or older day's versions will be removed.

On the other hand, if the newest version is not the current day, then only up to three file versions from the newest day will be retained in the backup area. There will be a maximum of three backup files retained for the next newest day, and a maximum of three for the next newest day. Again, namely the newest three from each of those days, if they exist. All other versions from the kept days are removed, and any fourth or older day's versions will be removed.

This filtering/purgation process automatically takes place in the background. That is, unbeknownst to the user. This filtering/purgation process happens with each and every backup, taking place only in the backup directory or directories where a new file version is being copied to. Directories not affected by any new file creations and/or modifications do not undergo the said automatic filtering process.

The end result of the filtering/purgation process is that the storage media is far less likely to take up the enormous amount of disk space that current technologies do. At the same time, the backup versions kept are far more likely to be what the user really needs kept.

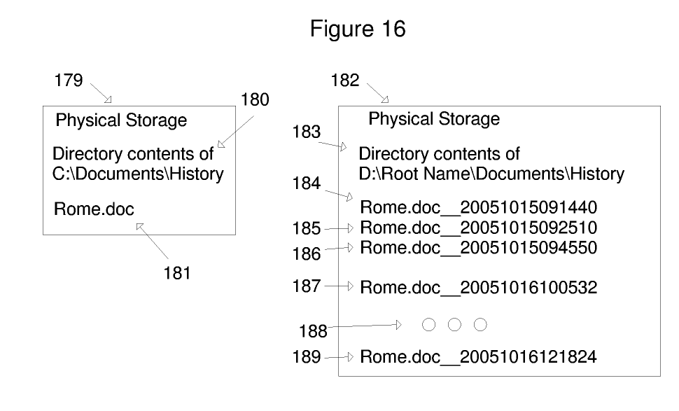

FIG. 16 is a pictorial of what could exist after two days of a user working on a single file. Assume that the current day is Oct. 16, 2005. The physical storage device 179 is assumed to be the user's main data storage area. Physical storage device 182 is meant to depict the user's backup directory. Note the similarity between the original 180 and backup 183 directory names. All backup file versions 184, 185, 186, 187, 188 and 189 are backups of the single file Rome.doc 181. The first three 184, 185, 186 are from the date 20051015. That is, Oct. 15, 2005. The rest are from the current day, 20051016. The dots 188 are meant to imply an arbitrary number of backed up file versions. Every time the user makes a change to Rome.doc and backs up, a new file version is created in the physical storage of 182. Let us now assume that there were really dozens of file versions from 20051015 at the start of the day 20051016. After the first backup of 20051016, all but the newest three file versions of Rome.doc from 20051015 would be removed, leaving only the three depicted. The state of the pictorial is what it would be after the user has backed up a number of times on 20051016, keeping in mind that all backed up file versions from the current day are kept.

There is another filtering provision in the current embodiment of the invention. The aforementioned filtering rules are kept, except that there is an additional provision such that if there are multiple days to be kept, any such day over six months of age can only have one copy from each said day kept. Namely, of course, the newest one of each such day. Here is an example. Assume that for a given original file, there are ten backed up versions from a day five months ago, three from a day six months ago and three from a day seven months ago. After filtering there will be the newest three of the day from five months ago, a single, newest file version of the day from six months ago, and a single, newest file version of the day from seven months ago.

The current embodiment of the invention has all of the filtering rules flexible such that the number of days to keep, the maximum number of copies to keep given the day, whether current, older, for how old a day, etcetera, are all easily changeable. They have in fact been changed quite a bit while testing.

This ends the explanation of the excess backup file version removal process.

In the current embodiment of the invention the FIG. 2 Main Menu 8 would stay showing, or be in minimized icon mode, but yet be sleeping until activated by the user by pressing a button. In this manner, the current embodiment stays in the ready mode without relatively taking up processor/cpu time. Referring back to the previously discussed idea of a student with a subtree Documents\History, once the student started using the invention, and had the experience of the said Back Up Now button being finished within a few seconds, it will very quickly become second nature. From personal experience I can attest that the good feeling of having the current work backed up coupled with the experience of having it be easy and quick, is more than enough positive feedback to make backing up a very frequent part of even a casual user's computing experience.

What is claimed is:

1. A computer backup system with improved backup storage comprising a memory means for storing one or more files comprising information, including a file name and attributes such as creation and modification dates.

2. Claim 1 with the means for modifying the file names by embedding or attaching a special character or characters such as an underscore, and a timestamp date, such as in the form _YYYYMMDDhhmmss, where YYYY is year, MM is month, DD is day, hh is hour, mm is minutes, ss is seconds.

3. Claim 2 with the means for creating the equivalent of a baseline or full backup, or the equivalent of a partial or differential backup, without having to differentiate which is which because the end result is always the equivalent of a full backup, thereby freeing a user from having to learn such terminology, coupled to said memory means, in which all said equivalent backups can proceed with the apparent speed of a partial backup once one initial backup has been completed, having each backed up version of a file be stored in the said memory means, or in any storage area allowed for the backup of files by the user operating system, into the same like named directory as the originating source except for a special root backup directory name, using the same file base name and file name extensions for the files that the original files have, modified as stated in claim 2, being or having been backed up, without operating system conflict.

4. Claim 3 having all resultant backed up file versions be readily searchable for file and/or directory names, using the search methods that come standard with the more popular current day operating system provided methods, and/or most popular software word processor provided methods.

5. Claim 3 having all the backed up files be readily searchable for file content with most current day popular operating system provided methods, and/or most popular software word processor provided methods.

6. Claim 3 having a method of setting up what is to be backed up all in one window, and yet separated into different data entry boxes each: for specific files to be backed up; for directories whose files are to be backed up, but not including backing up any subdirectories of the directories; and for directory trees to be backed up, which include backing up all files of all subdirectories under the directories, and any combination of the three can be used.

7. Claim 6 having sufficient succinct explanations and help buttons around the said boxes, with terminology appropriate to those said boxes, such that the user can be self guided without needing a manual in order to operate the system.

8. Claim 6 having the said method of setting up what is to be backed up by allowing the user to enter the data in the said boxes using direct typing, copy and paste, using a computer mouse to drag and drop, or by any other method by which the host computer allows data entry to be entered into such data entry boxes.

9. Claim 6 having a system whereby the already entered data in the above mentioned boxes can be easily modifiable by preceding any line with a special character, such as a pound sign # in the current embodiment of the invention, such that the system ignores the line if it begins with said special character, thereby making it even easier to modify what does and does not get backed up.

10. Claim 3 having a system wherein the backed up data is easily retrievable by mouse drag and drop of a backup file from one place to another in a file browser window, as allowed by the user operating system, or by command line copying from one place to another, or by opening a file in question itself into most standard word processors, or by any other means on an operating system that allows files to be moved, copied or edited, if edited, given the appropriate type of word processor/editor for the appropriate type of file.

11. Claim 3 having a system wherein the user can view a data entry box to specify a date for backing up such that no files/directories/trees in any combination will be backed up unless they were created and/or modified on or after that date, the box also having sufficient succinct explanations and help buttons around it, with clear enough examples, such that the user can be self guided without needing a manual in order to understand it.

12. Claim 3 having a system wherein the user can view a data entry box to specify a date for recovering files, directories, or trees such that no files, directories or trees will be recovered unless they were originally created and/or modified on or after that date, the box also having sufficient succinct explanations and help buttons around it, with clear enough examples, such that the user can be self guided without needing a manual in order to understand it.

13. Claim 3 having a system with a window with a data entry box for designating the location of where to back up to, which could be the said memory means, or any storage media that the user operating system will allow files to be backed up to, the box also having sufficient succinct explanations and help buttons around it, with clear enough examples, such that the user can be self guided without needing a manual in order to understand it.

14. Claim 3 having a system whereby excess backed up files are automatically removed in an intelligent manner, thereby making the storage media much less likely to fill up, by keeping all file versions of the current day of worked-in directories, having a maximum number of copies kept for the next oldest day, and also a maximum number of copies kept for the next oldest day, and having a maximum of three separate said days worth of file versions, with just the one, single, newest file version being kept if the newest is beyond a certain time period such as six months in the current embodiment of the invention, and, no matter how many days worth are kept, if a file version is older than a certain age, six months in the current embodiment, only one file version per kept day over the said certain age is kept.

15. Claim 3 with an included purgation system to filter excess backed up files throughout an entire backup area in the manner of claim 14, so the computer storage does not readily fill up with useless, repetitive backed up data, while minimizing the prospect of losing important data.
